(19) United States
(12) Patent Application Publication
(10) Pub. No.: US 2026/0035042 A1
(43) Pub. Date: Feb. 5, 2026

(54) Seasonally Adaptable Trailer with Interchangeable Modules

(71) Applicant: Exosent Engineering, LLC, Navasota, TX (US)

(72) Inventor: Yuval Doron, College Station, TX (US)

(73) Assignee: Exosent Engineering, LLC, Navasota, TX (US)

(21) Appl. No.: 19/287,323

(22) Filed: Jul. 31, 2025

Related U.S. Application Data
(60) Provisional application No. 63/677,864, filed on Jul. 31, 2024.

(51) Int. Cl. B62D 53/06; B60P 3/22; B60P 3/42

(52) U.S. Cl. CPC B62D 53/067; B60P 3/2215; B60P 3/225; B60P 3/426

(57) ABSTRACT

Apparatus and related methods relate to a trailer with interchangeable modules. In an illustrative embodiment, a trailer may be configured to be towed by a pickup truck with a bed. The trailer may, for example, include a chassis that is at least partially exposed. A drive module may, for example, be configured to generate rotary motion from an energy storage module. A plurality of interchangeable modules may, for example, be configured to selectively and releasably couple to the trailer via mount modules. The interchangeable modules may, for example, include a fluid transfer pump module configured to transfer fluid from an inflow conduit to a receptacle external to the trailer. A pressure vessel may, for example, be configured to transport hazardous gas. A flatbed deck may, for example, be configured to cover the chassis in at least the location of the pressure vessel. Various embodiments may advantageously provide seasonal adaptability.

### CROSS-REFERENCE TO RELATED APPLICATIONS

This application claims the benefit of U.S. provisional patent application Ser. No. 63/677,864, filed Jul. 31, 2024 (naming inventor DORON, Yuval) and titled “Seasonally adaptable hazardous fluid delivery trailer.”

The entire contents of each of the foregoing applications and their priority applications, if any, are incorporated herein by reference.

This application may share inventor(s) and/or subject matter with one or more of the following applications:
U.S. patent application Ser. No. 29/773,302, filed Mar. 9, 2021 (naming inventor(s) including DORON, Yuval) and titled “Projectile-shaped trailer air tank;”
U.S. patent application Ser. No. 63/157,428, filed Mar. 5, 2021 (naming inventor(s) including DORON, Yuval) and titled “Side mounted air supply for wheel lift independent of vehicle air brake;”
U.S. patent application Ser. No. 17/653,853, filed Mar. 7, 2022 (naming inventor(s) including DORON, Yuval) and titled “Side mounted air supply for wheel lift independent of vehicle air brake;”
U.S. patent application Ser. No. 29/718,772, filed Dec. 27, 2019 (naming inventor(s) including DORON, Yuval) and titled “Tank trailer airfoil;”
U.S. patent application Ser. No. 62/704,266, filed May 1, 2020 (naming inventor(s) including PEARSON, Gerald) and titled “Tank trailer airfoil structures and methods;”
U.S. patent application Ser. No. 17/302,366, filed Apr. 30, 2021 (naming inventor(s) including PEARSON, Gerald) and titled “Tank trailer airfoil structures and methods;”
U.S. patent application Ser. No. 18/328,526, filed Jun. 2, 2023 (naming inventor(s) including PEARSON, Gerald) and titled “Tank trailer airfoil structures and methods;” and
U.S. patent application Ser. No. 29/788,666, filed Jul. 13, 2021 (naming inventor(s) including DORON, Yuval) and titled “Tank winglet.”

The entire contents of each of the foregoing applications and their priority applications, if any, are incorporated herein by reference.

Unless expressly stated, changes in terminology from priority application(s) to this application are made without prejudice or disclaimer of subject matter. Changes from the priority application(s) (e.g., provisional applications(s)) are intended to be broadening and/or additive unless expressly stated otherwise. Replacement of alternative terms with a single representative term, for example, are inclusive unless otherwise defined. Various embodiments may also be found in previous disclosure(s) incorporated by reference. Embodiments of similar languages in this application are not modifications or disclaimer of the embodiments disclosed in previous incorporated disclosures unless otherwise stated.

### BACKGROUND

A truck (e.g., pickup truck, semi truck, lorry) may be configured a motor vehicle designed to transport cargo, carry specialized payloads, and/or perform other utility tasks. There may be various sizes, power output, and configurations of trucks. For example, some trucks may have a body-on-frame construction, with a cabin that is independent of the payload portion of the vehicle. In some examples, a pickup truck or pickup may be a light-duty truck with an enclosed cabin and an open cargo area. For examples, the open cargo area may include low sides and/or a tailgate. Commercial trucks may, for example, be configured to be mounted with specialized equipment. For example, a commercial truck may be configured with special equipment to be converted into a garbage truck, a fire truck, a concrete mixing truck, and/or a suction excavating truck. In some examples, some trucks may be configured to carry special payload like hazardous gas or liquid.

A gross vehicle weight rating (GVWR) is often used to classify a commercial truck. For example, in the United States, truck classes range from class 1-class 8. Trucks are also classified more broadly by the Federal Highway Administration (FHWA). For example, the FHWA may further group classes 1-2 as light duty trucks, classes 3-6 as medium duty trucks, and classes 7-8 as heavy-duty trucks. In some examples, light-duty trucks may sometimes be rated by their payload capacity in tons, (e.g., ½-ton trucks, ¾-ton trucks, 1-ton trucks).

Sometimes, a light-duty truck may be used for special purposes. For example, some light-duty trucks may be specially designed for their hauling and/or towing tasks, such as by utilizing body-on-frame design, and long wheelbase, for example. In some examples, a light-duty truck may be equipped with camper shells to provide a small living space for camping. In some examples, some light-duty trucks may be modified for carrying passengers. For example, in parts of Africa and Southeast Asia, “songthaews” may be converted from light-duty trucks and/or flatbed trucks. In Haiti, for example, “tap taps” may be converted from light-duty trucks.

### TECHNICAL FIELD

Various embodiments relate generally to interchangeable modules suitable for utility and cargo transportation vehicles.

### SUMMARY

Apparatus and related methods relate to a trailer with interchangeable modules. In an illustrative embodiment, a trailer may be configured to be towed by a pickup truck with a bed. The trailer may, for example, include a chassis that is at least partially exposed. A drive module may, for example, be configured to generate rotary motion from an energy storage module. A plurality of interchangeable modules may, for example, be configured to selectively and releasably couple to the trailer via mount modules. The interchangeable modules may, for example, include a fluid transfer pump module configured to transfer fluid from an inflow conduit to a receptacle external to the trailer. A pressure vessel may, for example, be configured to transport hazardous gas. A flatbed deck may, for example, be configured to cover the chassis in at least the location of the pressure vessel. Various embodiments may advantageously provide seasonal adaptability.

In some embodiments, a Multi-use Utility Trailer (MUT) may, for example, be configured to be towed by a truck. This configuration may advantageously allow for the transportation of various interchangeable modules without the need for a dedicated vehicle. A tank may, for example, be designed to withstand high internal pressures. This design may advantageously enable the safe transport of hazardous materials. A coupling module may, for example, allow for quick installation and/or removal of interchangeable modules. This feature may advantageously reduce downtime when switching between different tasks.

In various implementations, a removable delivery module may, for example, include power accessory equipment. This equipment may advantageously provide the necessary power for operating the MUT independently of the towing vehicle. The MUT may, for example, include a linear power transmission. This transmission may advantageously facilitate the extension of the flatbed to a loading dock, enhancing loading and unloading efficiency.

A multi-use hydraulic power delivery system may, for example, be installed independently of a tank. This installation may advantageously allow for the conversion of the trailer into a roll-off trailer, thereby increasing the versatility of the MUT.

A drive module may, for example, include an electric motor. This motor may advantageously provide a quieter and more environmentally friendly power source compared to traditional internal combustion engines.

In some examples, a MUT may, for example, be configured to fit different types of interchangeable beds. This configuration may advantageously extend the usage of the truck, such as by allowing it to perform multiple tasks without modification. The interchangeable modules may, for example, be self-contained. This self-containment may advantageously enable them to perform tasks without requiring external power from the truck, thereby increasing operational flexibility.

Interconnections between the delivery module and a tank may, for example, be designed for simple installation. This design may advantageously reduce costs associated with complex piping systems. A deck may, for example, provide a flatbed mode for the MUT. This mode may advantageously support a variety of cargo types, enhancing the trailer's utility.

### BRIEF DESCRIPTION OF THE DRAWINGS

FIG. 1A depicts an example Multi-use Utility Trailer (MUT) with a pressure vessel module employed in an illustrative use-case scenario.

FIG. 1B depicts another perspective view of the illustrative MUT in FIG. 1A.

FIG. 1C depicts an exploded view of the pressure vessel module from the MUT.

FIG. 2A shows an example MUT with a flatbed deck module, and FIG. 2B shows an example frame of the flatbed deck module.

FIG. 3A and FIG. 3B depict perspective views of the example MUT of FIG. 1A with the pressure vessel module removed (e.g., configured as a bare MUT ready to receive another module(s)).

FIG. 4A and FIG. 4B depict side and bottom views, respectively, of the example pressure vessel module shown in FIG. 1A.

FIG. 5A and FIG. 5B show a close-up perspective view of the MUT with an example drive module. FIG. 5C depicts an exploded view of the drive module of FIG. 5B. FIG. 5D depicts a top view of the drive module of FIG. 5B.

FIG. 6 depicts an example MUT with an example pressure vessel module and an example delivery module.

FIG. 7 depicts the example MUT of FIG. 6 with the pressure vessel module removed and the delivery module still installed.

FIG. 8A and FIG. 8B depict close-up views of the example delivery module of FIG. 6. FIG. 8C depicts an example drive module in the MUT of FIG. 6.

FIG. 9 depicts an example MUT with a pressure vessel module and rear-mounted delivery module.

Like reference symbols in the various drawings indicate like elements.

### DETAILED DESCRIPTION OF ILLUSTRATIVE EMBODIMENTS

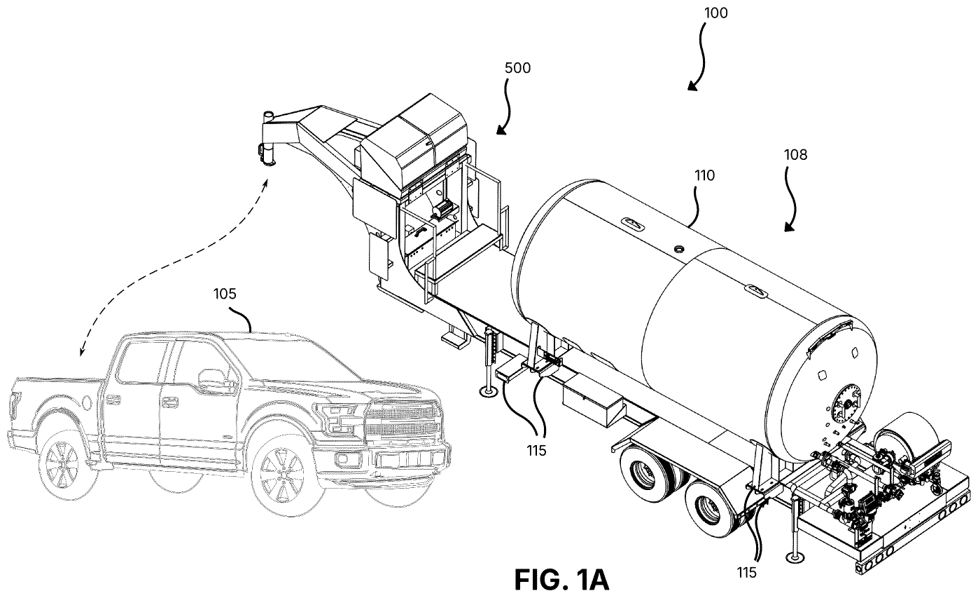

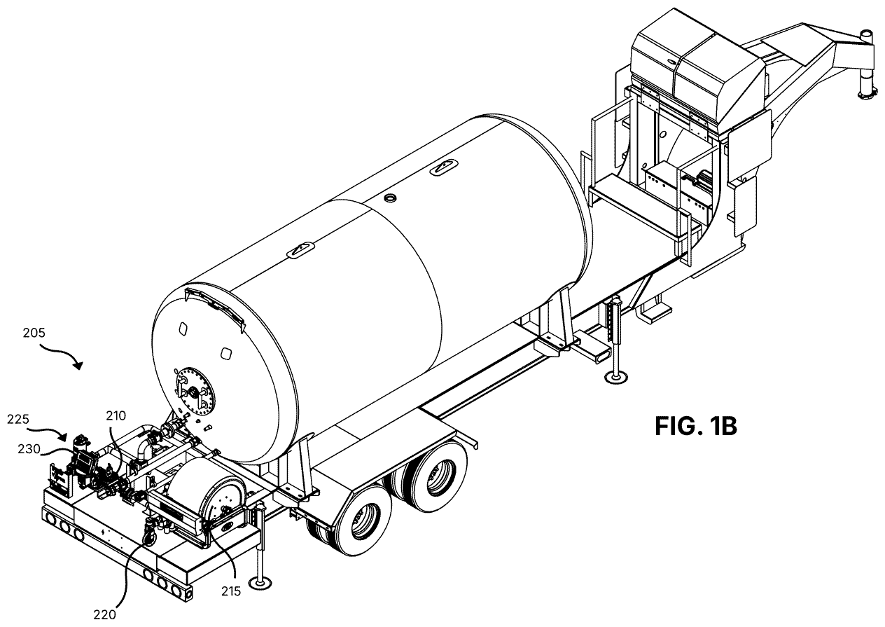

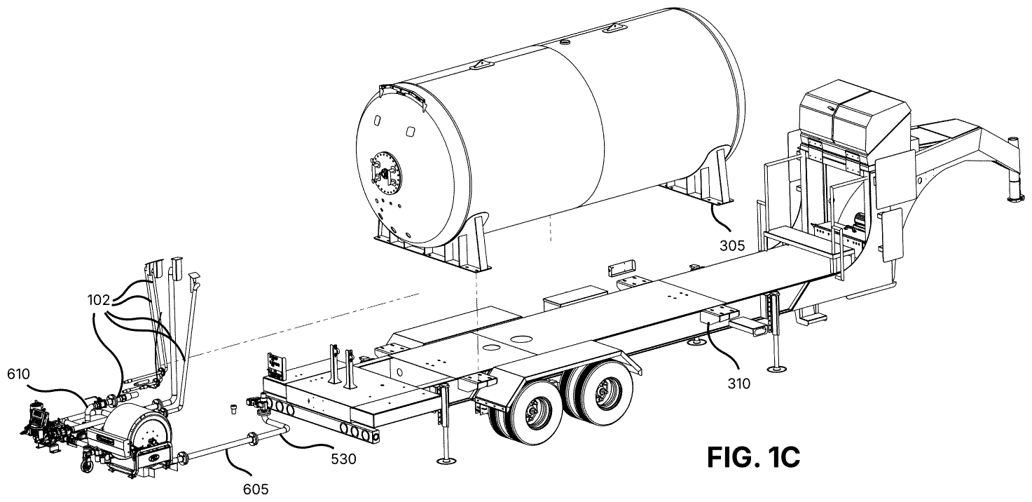

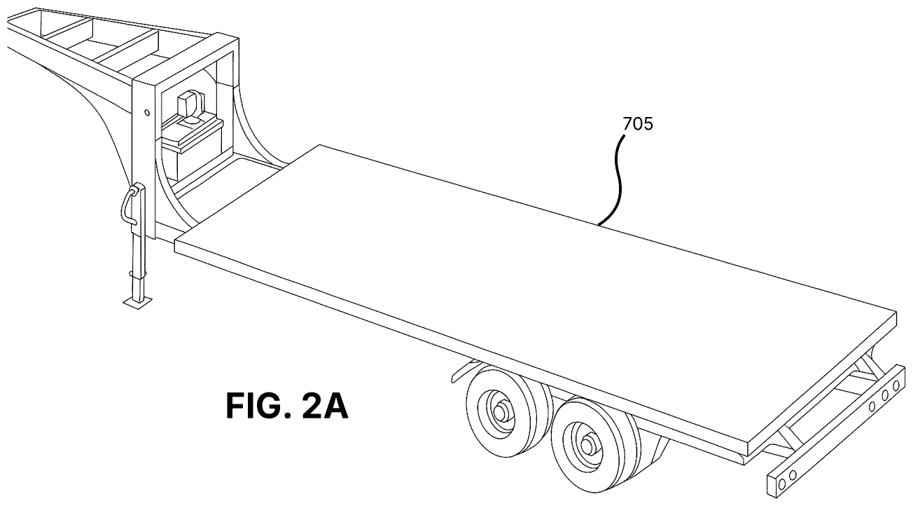

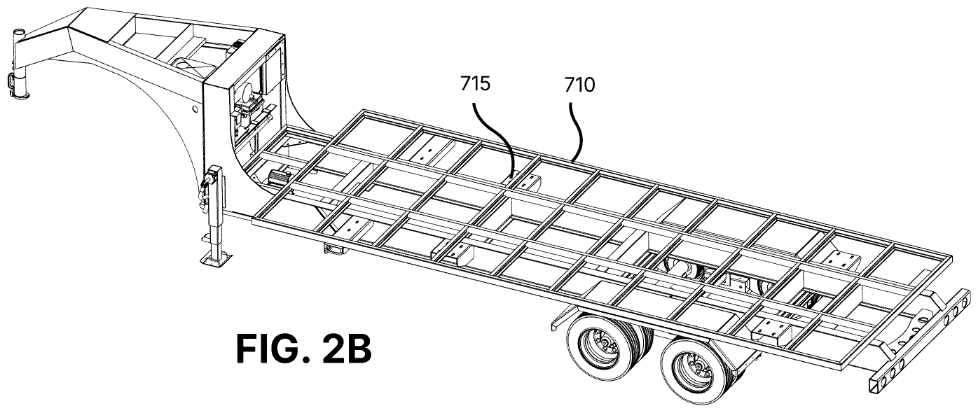

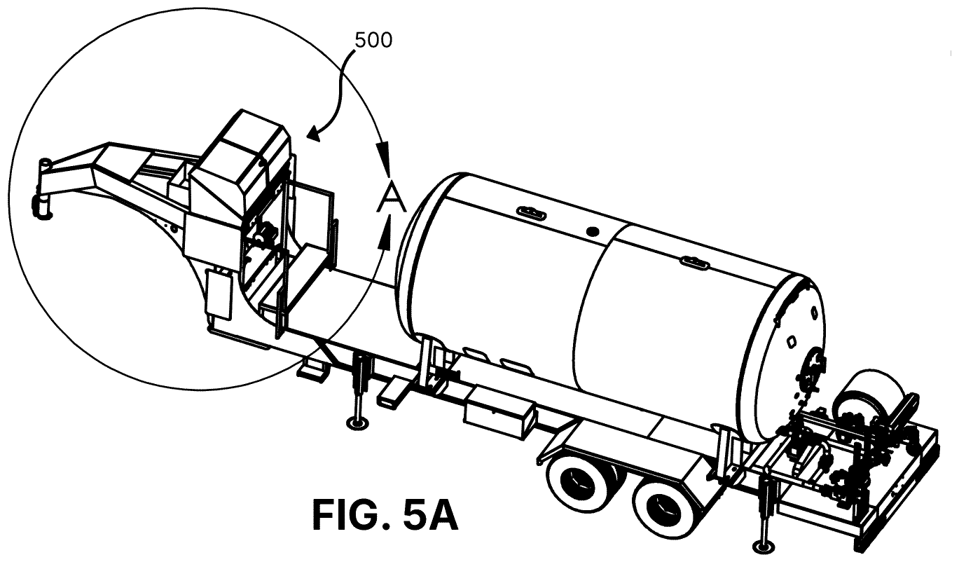

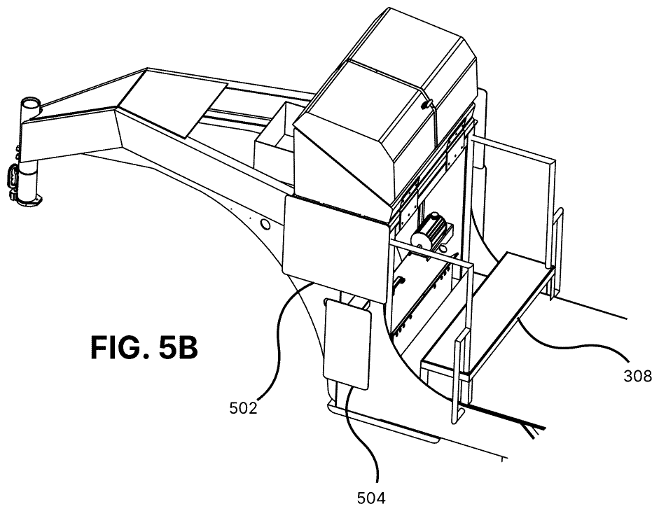

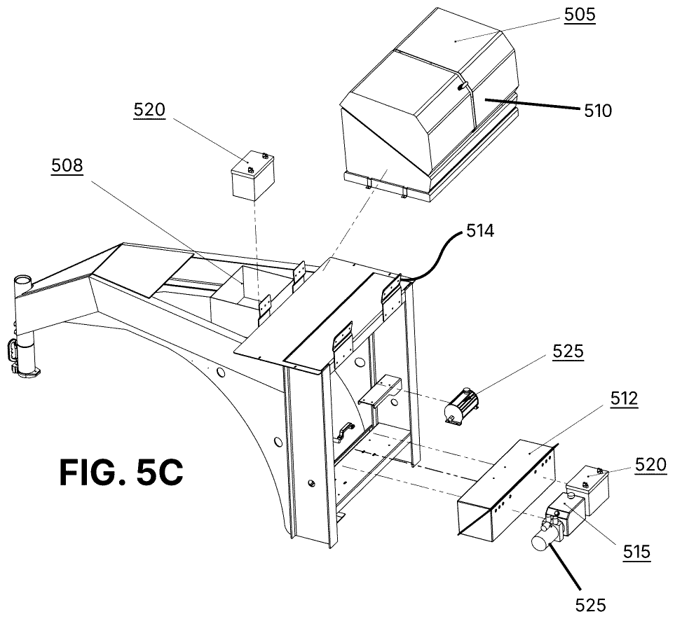

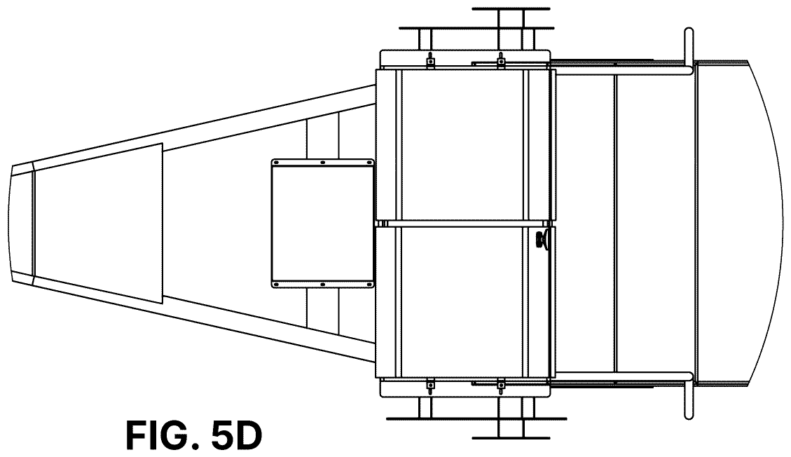

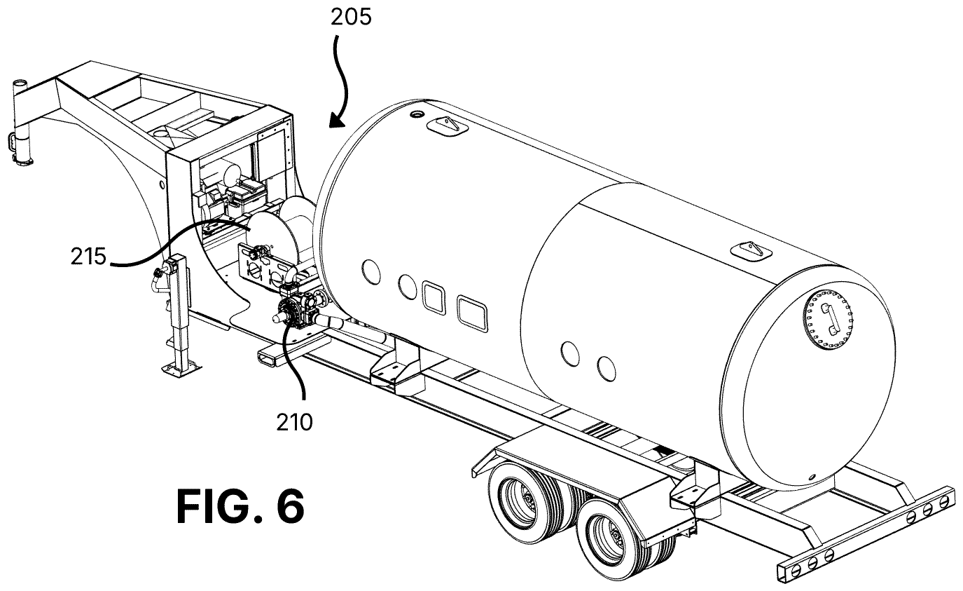

To aid understanding, this document is organized as follows. First, to help introduce discussion of various embodiments, a propane gas delivery system using an exemplary Multi-use Utility Trailer (MUT) with interchangeable modules is introduced with reference to FIGS. 1A-1C. Second, that introduction leads into a description with reference to FIGS. 2A-4B of various exemplary interchangeable modules. Third, and with respect to FIGS. 5A-5D, an illustrative drive module is discussed. Fourth, with reference to FIGS. 6-9, the discussion turns to exemplary embodiments and configurations. Finally, the document discusses further embodiments, exemplary applications and aspects relating to the MUT.

FIG. 1A depicts an example Multi-use Utility Trailer (MUT) with a pressure vessel module employed in an illustrative use-case scenario. FIG. 1B depicts another perspective view of the illustrative MUT in FIG. 1A. As an illustrative example, the MUT 100 is towed by a truck 105. The truck 105 may, for example, be a light-duty pickup. As shown, the truck 105 is provided with a bed (e.g., with sides, as shown). For example, the truck 105 may be a ¾-ton class or greater pick-up truck. In some examples, the truck 105 may be a class 3-6 medium truck. In some examples, as shown, the MUT 100 may be a gooseneck trailer designed to be moved via the truck 105. In some examples, the MUT 100 may be coupled to the truck 105 using a pintle hook and ball mechanism. In some examples, the MUT 100 may be coupled to the truck 105 using an inverted fifth wheel.

In this example, the MUT 100 is fitted with a pressure vessel module 108 by mechanical means. As shown, the pressure vessel module 108 includes a tank 110. For example, the tank 110 may be a high-pressure gas tank. In some implementations, the tank 110 may be designed to withstand an inside gas pressure of at least 100 pounds per square inch (psi). In some embodiments, the tank 110 may be configured to withstand (e.g., up to) 600 psi from its payload. In some examples, the tank 110 may be designed for carrying hazardous material such as explosive gases. As shown, the pressure vessel module 108 is releasably fastened to the MUT 100 by coupling modules 115 (e.g., mount modules).

In some examples, the coupling modules 115 may be oriented to extend outwardly from the chassis of the MUT 100 along corresponding longitudinal axes. These axes may intersect a longitudinal axis of the chassis. This orientation may facilitate the secure attachment of interchangeable modules. The orientation of the coupling modules 115 may, for example, allow for efficient distribution of forces. Efficient force distribution may reduce stress on the tank 110 and/or chassis. In some embodiments, the coupling modules 115 may be configured to align with corresponding mounts on the interchangeable modules. This configuration may enable quick installation and removal. Quick installation and removal may advantageously enhance the versatility and adaptability of the MUT 100 for various tasks. In some examples, it may also be easier to access the coupling modules 115. Easier access may, for example, improve maintenance efficiency.

In some implementations, other interchangeable modules may be configured to be releasably fastened to the coupling modules 115. For example, the pressure vessel module 108 may be removed and be replaced by a flatbed deck 705 module on the MUT 100. In some examples, a user may interchangeably couple various modules to the MUT 100 for different usages. As an example, without limitation, the user may attach a propane gas tank during the winter for using the truck 105 in propane delivery. For example, during an off-season for the propane, the user may replace the propane gas tank with a flatbed deck 705 for using the truck 105 in transporting dry bulk cargo. Accordingly, the user may, in various embodiments, use the MUT 100 for multiple usage without modifying the truck 105 for a dedicated purpose.

FIG. 1C depicts an exploded view of the pressure vessel module from the MUT. Example coupling modules 115 of the MUT 100 are depicted. For example, the coupling module 115 may be a vessel mount 305 and a trailer mount 310 fastened together by nuts and bolts. In some implementations, the coupling module 115 may include fast secure fasteners for quick install and release. For example, the coupling module 115 may include an attachment clip that couple the vessel mount 305 and the trailer mount 310 together.

In various implementations, the MUT 100 may be configured to fit different types of interchangeable beds. For example, a user may dismount the tank 110 and associated equipment, such as the delivery module 205. Then, for example, the user may convert the MUT 100 into a flatbed trailer by mounting a flatbed onto the MUT 100. In some implementations, various modules may be advantageously configured to fit the coupling module 115 such that the MUT 100 may extend the usage of the truck 105. Accordingly, by utilizing a same truck while interchanging different modules on the MUT 100 for different tasks, the user may reduce costs for performing various tasks.

The delivery module 205 in this example rotates about a pivot point, supported by the wheel 220. This configuration may allow the hose to easily access a side or front of the MUT. The rotation about the pivot point may facilitate flexible positioning of the hose, enhancing operational convenience. In some examples, the delivery module 205 may be configured to rotate to various angles, providing adaptability for different operational scenarios. The ability to access multiple sides of the MUT may, for example, improve the efficiency of fluid transfer tasks.

The delivery module 205 may, for example, include a control 225, as depicted. In some examples, the control mechanism may regulate the operation of the delivery module 205. The delivery module 205 may, for example, further include a meter 230. In some examples, the metering device may facilitate the dispensing of contents from the pressure vessel module 108. For example, the control 225 may include the meter 230. The control 225 may, for example, operate a valve in response to the meter 230.

Also depicted is conduit 530. For example, a product suction 605 connects the tank 110 to an inlet of the delivery module 205 fluid transfer pump. As depicted, the conduit 530 includes a product return 610. The product return 610 may, for example, allow for the return of fluids from the pump to the tank 110. Other conduits depicted may, for example, allow access (e.g., filling, draining, and/or venting) of the tank 110.

FIG. 2A shows an example MUT with a flatbed deck module, and FIG. 2B shows an example frame of the flatbed deck module. An MUT may, for example, be provided with an interchangeable deck module. In this example, the MUT 100 is shown with a deck 705 installed. The deck 705 is provided with a deck frame 710. The deck frame 710 may, for example, releasably couple to the coupling modules 115 of the chassis 300.

As shown, the delivery module 205 (e.g., configured as a fluid transfer pump), the tank 110, and the MHPDS 405 are removed. The drive module 500 is still installed. For example, the deck 705 may be provided with a deck surface. The deck 705 may, for example, provide a flatbed mode for the MUT 100. In some examples, the deck 705 may be configured to mount to the MUT 100 with one or more other interchangeable module(s) (e.g., the MHPDS 405). In some examples, the deck 705 may be configured as a tilt bed.

FIG. 2A shows an exemplary schematic of the MUT 100. The MUT 100 includes a removable tank 110 and a removable delivery module 205. For example, the removable delivery module 205 may be releasably fastened to the MUT 100 by bolting on a platform of the MUT 100. In some implementations, the removable delivery module 205 may be connected to the removable tank 110 such that a content in the removable tank 110 may be delivered via a product pump 210. The product pump 210 may, for example, deliver the product (e.g., propane gas) through a hose. For example, the product pump 210 may be fluidly coupled to the hose through a reel 215, such as via conduit 530 (see FIG. 5).

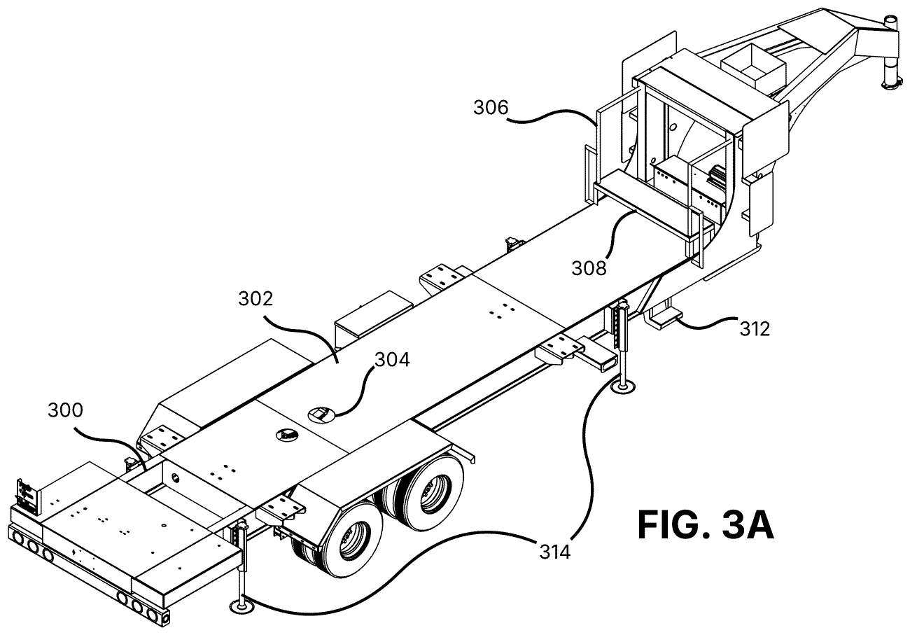

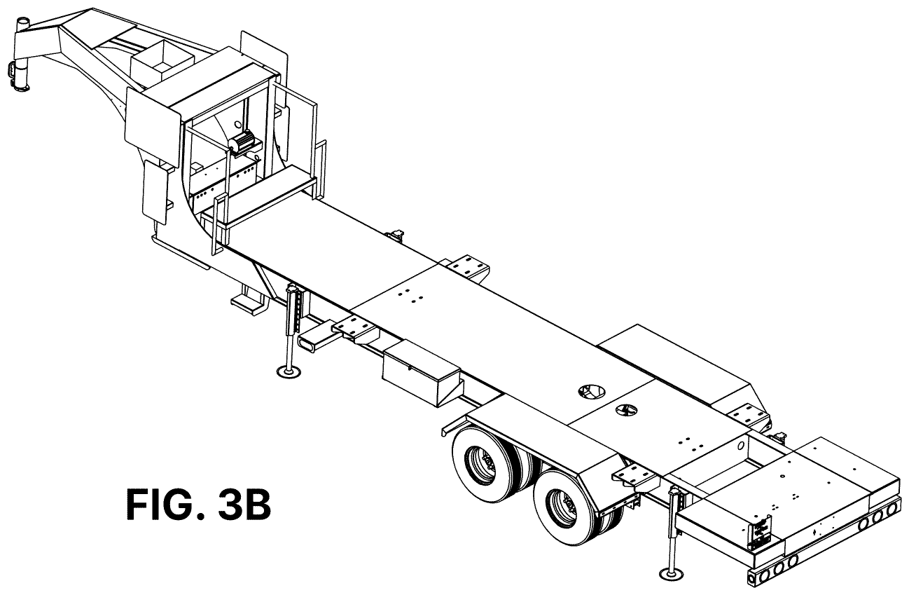

FIG. 3A and FIG. 3B depict perspective views of the example MUT of FIG. 1A with the pressure vessel module removed (e.g., configured as a bare MUT ready to receive another module(s)). The MUT 100 is provided with a chassis 300, shown exposed (partially) in this embodiment. A chassis shield 302 is disposed over at least part of the chassis 300. The chassis shield 302 may, for example, assist placement of interchangeable modules. For example, as shown, a top surface of the chassis 300 and/or the chassis shield 302 may be flush with an upper surface of the coupling module 115. In some embodiments, the coupling module 115 upper surface(s) may be elevated above the chassis 300 and/or chassis shield 302 (e.g., at least in a region corresponding to the coupling module 115).

Item, an access port 304 is integrated into the chassis 300. The access port 304 may, for example, facilitate maintenance and/or inspection. In some embodiments, the access port 304 may advantageously enable access for installation and/or removal of the access port 304 and/or interchangeable modules (e.g., providing access to a locking component).

In some examples, a handrail 306 may be mounted on the platform 308. The handrail 306 may, for example, enhance safety for users. The platform 308 may extend along the chassis 300. Extending the platform 308 along the chassis 300 may, for example, serve as a working surface. In some embodiments, a step 312 may be attached to the platform 308. Attaching the step 312 to the platform 308 may, for example, allow for easy access to elevated areas. The step 312 and platform 308 may, for example, provide a continuous access path from the ground to a drive module 500, for example.

Some examples, such as depicted, may include a stabilizer 314 connected to the chassis 300. The stabilizer 314 may, for example, be hydraulic. In some examples, the stabilizer 314 may be manual. The stabilizer 314 may, for example, be electric in some embodiments. In some examples, the stabilizers may prevent tilting of the trailer. The stabilizers may, for example, prevent movement of the trailer during operation. In some embodiments, the stabilizers may prevent movement during interchanging modules. Connecting the stabilizer 314 to the chassis 300 may, for example, provide additional support and balance during operation.

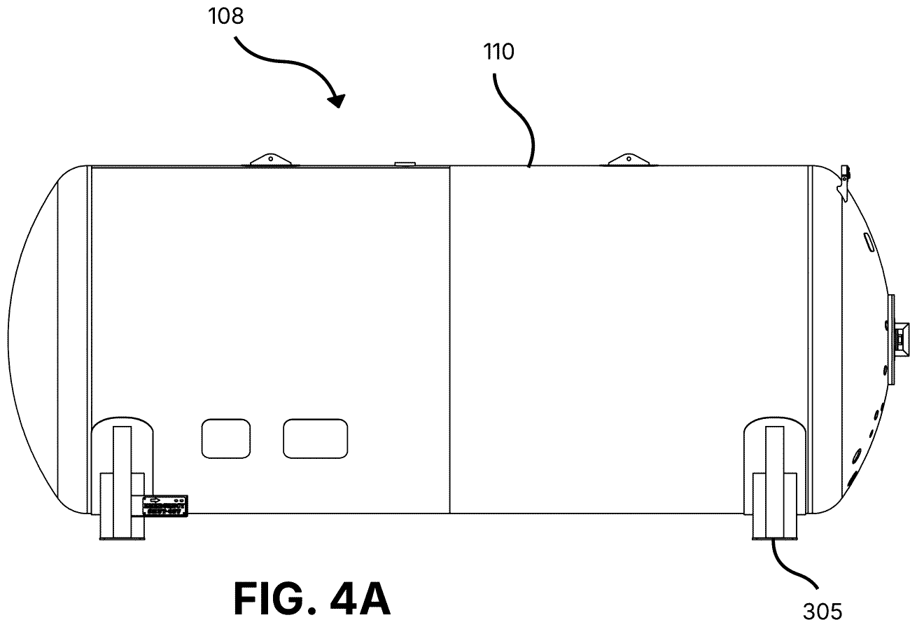

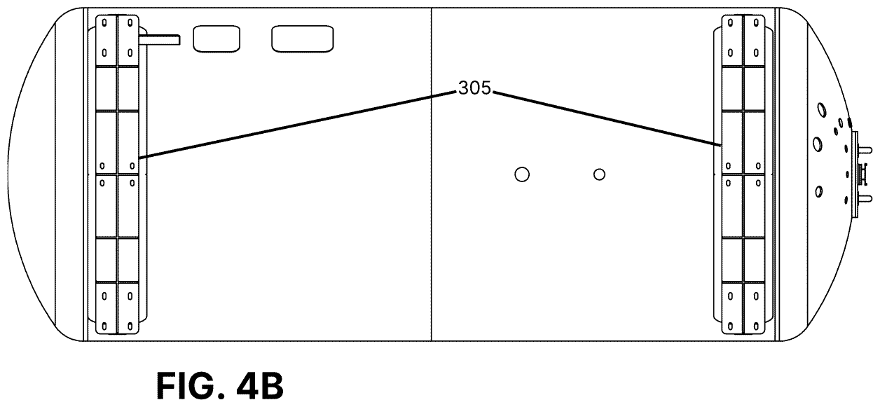

FIG. 4A and FIG. 4B depict side and bottom views, respectively, of the example pressure vessel module shown in FIG. 1A. The pressure vessel module 108 is shown including the tank 110. The tank 110 is supported by a vessel mount 305 (e.g., a coupling module 115). The vessel mounts 305 may, for example, be configured to releasably couple to corresponding trailer mounts 310 (e.g., coupling modules 115).

As shown in FIG. 4B, the vessel mount 305 may extend across a width of the tank 110. This configuration may, by way of example and not limitation, facilitate efficient distribution of forces, which may, for example, reduce stress on the tank 110 and/or chassis 300.

FIG. 5A and FIG. 5B show a close-up perspective view of the MUT with an example drive module. FIG. 5C depicts an exploded view of the drive module of FIG. 5B. FIG. 5D depicts a top view of the drive module of FIG. 5B. In this example, the drive module 500 is positioned at the front of the MUT 100.

Turning to FIG. 5B, the platform 308 is depicted with a solar panel 502 mounted on the neck 700. The solar panel 502 may provide renewable energy to the system (e.g., one or more power store 520). In some examples, a solar panel (e.g., on a pole) may be provided as part of an interchangeable module (e.g., a delivery module 205).

An accessory mount 504 is also shown. The accessory mount 504 may, for example, be configured to permit attachment of additional components and/or tools. This capability may increase the system's versatility.

An engine 505 is connected to a power store housing 508. For example, a generator module may, as shown, include the engine 505 and a motor 510 (e.g., a generator head). The generator module may, as depicted, be coupled to the neck 700 via ramped brackets 514. A ramped bracket 514 may, for example, provide structural support and/or alignment. For example, the ramping may facilitate easier insertion of the generator module.

The power store housing 508 houses a power store 520 (e.g., a battery). The generator may, for example, be electrically coupled to one or more of the power stores 520. The power store 520 in the power store housing 508 may, for example, be electrically coupled to power trailer accessory functions and/or the hydraulic pump 525.

A hydraulic power module 512 is disposed in the neck. The reservoir 515 may, for example, store hydraulic fluid. The reservoir 515 may, for example, be fluidly coupled to a hydraulic pump 525. The hydraulic pump 525 may, for example, be fluidly coupled to equipment (e.g., jack, pump, etc.). In this example, one hydraulic pump 525 may power hydraulic brakes of the MUT 100. The other hydraulic pump 525 depicted may, for example, power hydraulic jacks (e.g., front landing gear, stabilizers 314). The power store 520 in the hydraulic power module 512 may, for example, be electrically coupled to power the corresponding hydraulic pump 525.

FIG. 6 depicts an example MUT with an example pressure vessel module and an example delivery module. In various implementations, the MUT 100 may be self-contained. For example, the removable delivery module 205 may include power accessory equipment to power necessary components for using the MUT 100. For example, the removable delivery module 205 may include a power module to power a hydraulic winch to deliver propane gas via the product pump 210. In various examples, the MUT 100 may couple with modules that further include direct and/or indirect power transmission (e.g., rotary, linear) for various tasks. For example, the MUT 100 may include a linear power transmission for extending the MUT 100 flatbed to a loading dock. In some examples, the MUT 100 may include a power transmission to lift a dump flatbed. In some examples, the MUT 100 may include a rotatory power transmission to unload cargo, such as hay, to a side of the MUT 100.

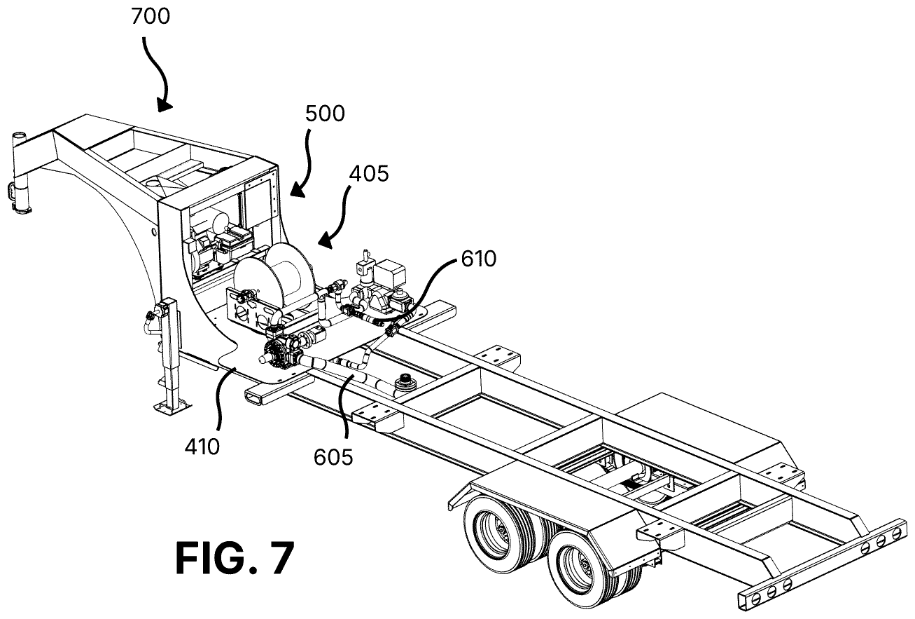

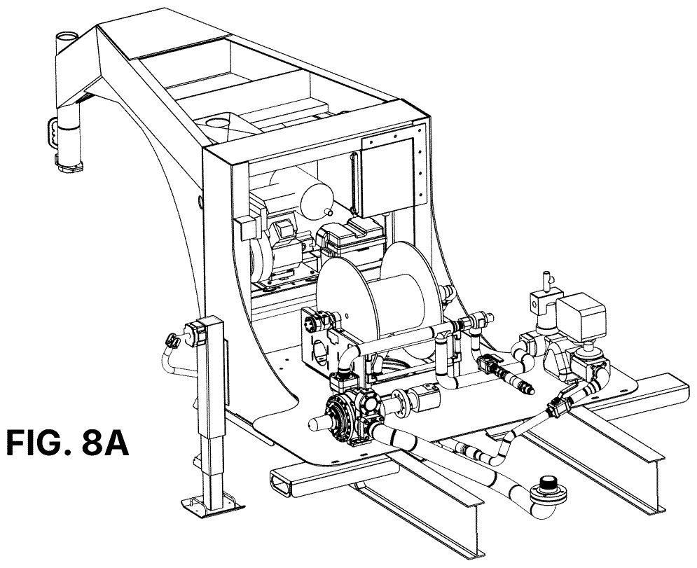

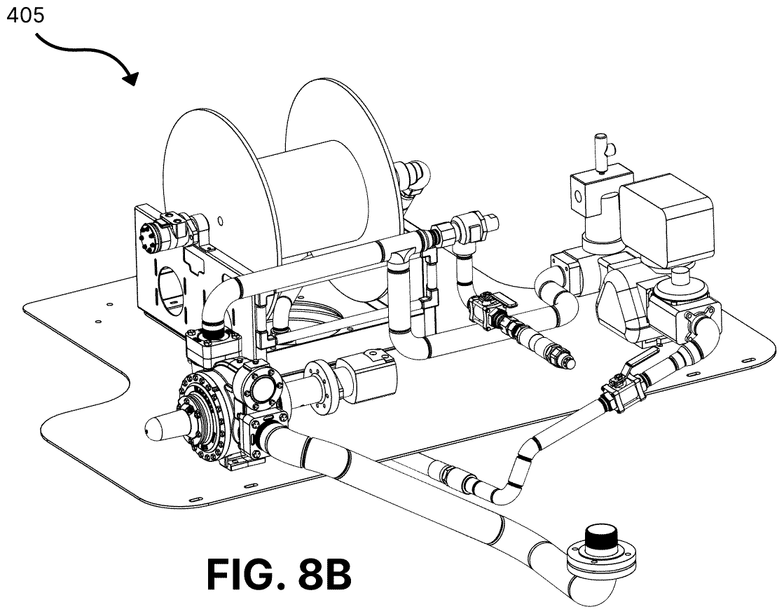

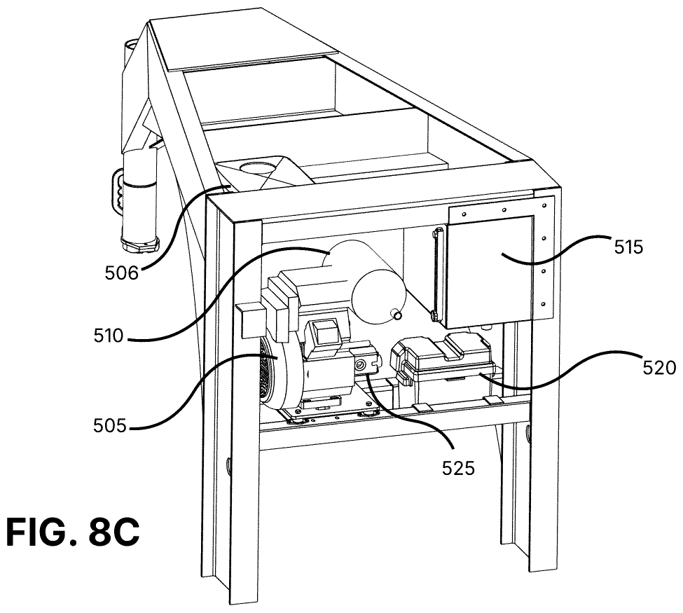

FIG. 7 depicts the example MUT of FIG. 6 with the pressure vessel module removed and the delivery module still installed. FIG. 8A and FIG. 8B depict close-up views of the example delivery module of FIG. 6. FIG. 8C depicts an example drive module in the MUT of FIG. 6. FIGS. 7-8C depict an example MUT 100 with a multi-use hydraulic power delivery system (an MHPDS 405). In some implementations, for example, the delivery module 205 may include at least part of the MHPDS 405.

In some embodiments, as shown, the MHPDS 405 may be installed on the MUT 100 interchangeably and independent of the pressure vessel module 108. For example, the MHPDS 405 may include a mount 410. The MHPDS 405 may be unitarily mounted and/or removed from the frame of the MUT 100 by coupling/decoupling the mount 410 to the MUT 100. For example, the mount 410 may be coupled to the MUT 100 via one or more of the coupling modules 115.

In this example, the MHPDS 405 is coupled to the tank 110 to drive product delivery from the tank 110 to the product pump 210. In some implementations, the MHPDS 405 may convert a trailer into a roll-off trailer. For example, the MHPDS 405 may be fluidly coupled to hydraulic actuators (e.g., pump(s), cylinders). The actuators may, for example, be configured to mount/demount, and/or otherwise operate a flatbed. For example, operating the flatbed may include tiling the flatbed. For example, operating a module may include operating a hydraulic winch (e.g,. to mount/dismount, roll/unroll a cover, tilt). In some implementations, a user may selectively reuse one or more interchangeable modules on the MUT 100. For example, a refitting cost may advantageously be reduced for refitting the MUT 100 from one usage to another usage by reusing one or more interchangeable modules (e.g., a MHPDS 405).

In some embodiments, for example, interchangeable modules may be coupled to the MUT 100. In this example, the MUT 100 is coupled to three interchangeable modules. The interchangeable modules includes the tank 110, the MHPDS 405, and a drive module 500.

For example, the drive module 500 may include an engine and/or motor. For example, the drive module 500 may include an electric motor 510. The electric motor 510 may, for example, be operably coupled to receive power from a power store 520 (e.g., battery). In some examples, the electric motor 510 may, for example, be configured to operate as a starter motor. In some examples, the electric motor 510 may, for example, be configured to operate as a multi-use motor.

In some examples, such as shown, the drive module 500 may include an engine 505. The engine 505 may, for example, be powered by liquid fuel (e.g., gasoline, diesel, kerosene, propane). In some implementations, the engine 505 may be powered by propane (e.g., from the tank 110, from a reservoir 506). The engine 505 and/or the electric motor 510, for example, may drive the MHPDS 405 to pump a product on and off the tank 110 (e.g., in addition to or in replacement of the product pump 210).

In some examples, the electric motor 510 and/or the engine 505 may drive a winch.

In some examples, the reservoir 515 may be a hydraulic reservoir. For example, the electric motor 510 and/or the engine 505 may be configured to drive a hydraulic pump 525. The hydraulic pump 525 may, for example, be configured to operate lift jacks. The hydraulic pump 525 may, for example, be configured to operate a tilt deck and/or dump bed (e.g., interchangeable module(s)). The hydraulic pump 525 may, for example, be configured to operate brake(s) and/or axle(s).

In some examples, the drive module 500 may include a generator (not shown). The generator may, for example, be operated by the engine 505. The generator may, for example, generate electricity. The generator may, for example, be configured to charge the power store 520. The generator may, for example, be configured as an alternator. In some examples, the generator may be electrically coupled to one or more interchangeable modules. The interchangeable module(s) may, for example, include those shown and/or described herein. In some examples, the interchangeable module(s) may, for example, include a welder (e.g., arc welder). For example, a welder module may be mounted to the MUT 100.

In some examples, the interchangeable modules may advantageously be self-contained. For example, the interchangeable modules may perform a task without receiving external power from the truck 105.

In various implementations, the drive module 500 may be used to independently power different systems. For example, the drive module 500 may be used to power a trailer home module. For example, the drive module 500 may also be used to power a dump flatbed. In some examples, the drive module 500 may be used to power a self-dumping hay deck that may include a rotational dumper to rotatably dump haystacks.

FIG. 8B, among others, depicts exemplary interconnections between the delivery module 205 and the (e.g., gas) tank 110. In this example, the delivery module 205 is connected (e.g., releasably, selectively) to the tank 110 via a product suction 605 and a product return 610. In various embodiments, the tank 110 and the delivery module 205 may be installed on the MUT 100 separately. For example, the delivery module 205 may be installed before the gas tank 110 for a purpose other than pumping gas from a gas tank. For example, the tank 110 may be installed later when there is a need to transport propane gas. In some examples, a user may connect the gas tank 110 to the delivery module 205 by merely connecting the product suction 605 and the product return 610. In some implementations, this simple installation procedure may reduce costs for delicately installed piping for propane delivery.

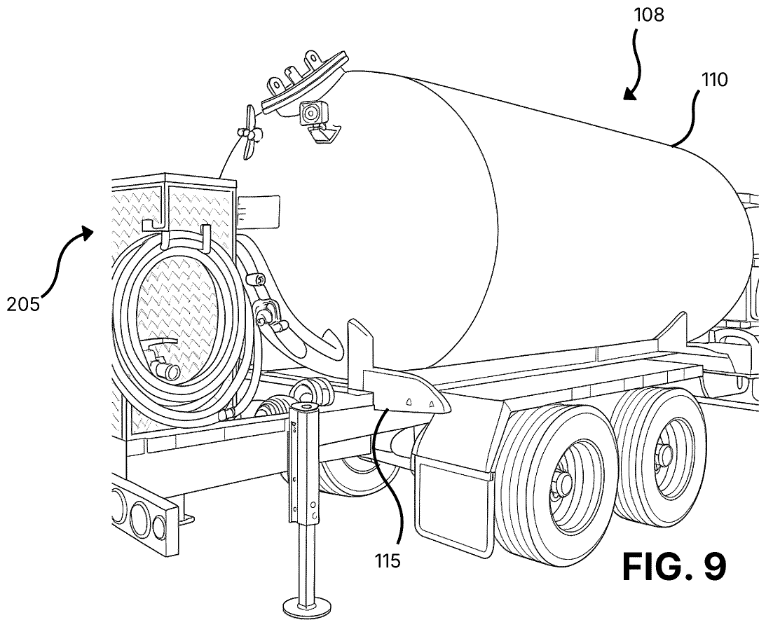

FIG. 9 depicts an example MUT with a pressure vessel module and rear-mounted delivery module.

Although various embodiments have been described with reference to the figures, other embodiments are possible. For example, the MUT 100 may be coupled to passenger vehicles to provide various utility. In some implementations, the MUT 100 may be coupled, through a pintle hook and ball, to a sports utility vehicle.

Although an exemplary system has been described with reference to the figures, other implementations may be deployed in other industrial, scientific, medical, commercial, and/or residential applications. In some embodiments, the Multi-use Utility Trailer (MUT) may be utilized in industrial applications. The trailer may, for example, be equipped with a fluid transfer pump module to facilitate the transfer of industrial fluids, such as lubricants or chemicals, from storage tanks to machinery. This configuration may enhance operational efficiency in industrial settings. The mobile solution for fluid management may provide this advantage.

In various embodiments, the MUT may be applied in medical scenarios. The trailer may, for example, include a pressure vessel module configured to transport medical gases, such as oxygen or nitrous oxide, to healthcare facilities. This application may provide a reliable and safe method for delivering gases to medical environments. Supporting patient care and treatment may be an advantage of this method.

In some embodiments, the MUT may be employed in scientific research applications. The trailer may, for example, be fitted with a flatbed deck module to transport sensitive scientific equipment to remote research sites. This configuration may allow researchers to conduct field studies with the necessary tools and instruments. Expanding the scope of scientific exploration may be a potential result.

In various embodiments, the MUT may be utilized in military operations. The trailer may, for example, be equipped with a drive module that includes an electric motor. This configuration may provide a stealthy and efficient means of transporting supplies or equipment in tactical environments. Enhancing the operational capabilities of military units may be an advantage of this application.

In some embodiments, the MUT may be applied in residential settings. The trailer may, for example, include a multi-use hydraulic power delivery system (MHPDS) to facilitate tasks such as landscaping or home improvement projects. This application may provide homeowners with a flexible and powerful tool for managing various residential tasks. Reducing the need for multiple specialized vehicles or equipment may be a potential advantage.

In some embodiments, the Multi-use Utility Trailer (MUT) 100 may include a non-pressurized vessel module. This module may, for example, be configured to transport non-hazardous liquids, such as water or agricultural products. In some examples, the non-pressurized vessel module may include a container with a sealable lid. The sealable lid may, for example, prevent spillage during transport. The inclusion of a non-pressurized vessel module may allow for the safe and efficient transport of liquids that do not require pressure containment. In some embodiments, the non-pressurized vessel module may be configured to transport hydrocarbon fuels, such as diesel, gasoline, or kerosene. The non-pressurized vessel module may, for example, be fluidly coupled to the delivery module 205. This configuration may, for example, facilitate the transfer of liquids from the vessel module to the delivery module.

In various embodiments, a tank may include baffles. These baffles may, for example, be positioned within the tank. The baffles may reduce liquid movement during transit. The reduction of liquid movement may minimize the risk of liquid surge, which can enhance the stability of the trailer while in motion.

Some embodiments may include a tank with a drainage system. This system may, for example, include a valve and hose connection at the base of the tank. The drainage system may facilitate the controlled release of liquid contents. The controlled release may allow for easy unloading of liquids at the destination, improving operational efficiency.

In various embodiments, a tank may be designed to be easily interchangeable with other modules on the MUT. This design may, for example, include standardized mounting points that align with the mount modules on the trailer chassis. The ability to quickly swap modules may enhance the versatility of the MUT, allowing it to be adapted for different tasks as needed.

In some embodiments, the Multi-use Utility Trailer (MUT) may include aerodynamic elements, such as airfoils, integrated into the trailer's chassis. These airfoils may be positioned to reduce aerodynamic drag when the trailer is in motion. Reduced drag may, for example, enhance fuel efficiency during transport. Some embodiments may include specific interchangeable modules, such as the flatbed deck module and the pressure vessel module, equipped with aerodynamic elements. These elements may include, for example, streamlined covers or fairings that align with the module's surface. Streamlined covers may, for example, improve airflow over the module. Improved airflow may potentially reduce wind resistance. In various embodiments, the fluid transfer pump module may incorporate airfoils designed to direct airflow around the module. This configuration may, for example, minimize turbulence. Minimizing turbulence may improve the stability of the trailer during high-speed travel. In some embodiments, the pressure vessel module may include aerodynamic fairings that conform to the shape of the tank. These fairings may, for example, reduce the aerodynamic profile of the module. Reducing the aerodynamic profile may be advantageous for maintaining consistent towing performance. Various embodiments of the MUT may include adjustable aerodynamic elements, such as retractable airfoils. These airfoils may be adjusted based on the trailer's speed or load conditions. Adjusting the airfoils may allow for dynamic optimization of aerodynamic performance. Dynamic optimization may, for example, provide improved handling and stability under varying operational conditions.

For example, some embodiments may be configured with airfoils as disclosed at least with reference to FIGS. 1A-6 of U.S. Pat. No. 11,702,150 (Gerald Pearson and Yuval Doron), FIGS. 1-8 of U.S. Design Patent D994540 (Yuval Doron, Gerald Pearson), and/or the figures of U.S. design application Ser. No. 29/718,772 (Gerald Pearson), the entire contents of which are incorporated herein by reference.

Some embodiments may have dedicated pneumatic and/or hydraulic brakes. For example, some embodiments may be configured as disclosed at least with reference to FIGS. 1A-6 of U.S. patent application Ser. No. 17/653,853 (Gerald Pearson, Yuval Doron, Manuel Gutierrez), the entire contents of which are incorporated herein by reference.

In an embodiment, the Multi-use Utility Trailer (MUT) may include a solar panel integrated into the chassis. This solar panel may, for example, generate renewable energy to power the drive module or any other electrical components on the trailer. The use of solar energy may advantageously reduce reliance on external power sources and decrease operational costs.

In another embodiment, the MUT may include accessory mounts positioned along the chassis. These accessory mounts may, for example, be configured to secure additional components such as toolboxes or lighting systems. The inclusion of accessory mounts may enhance the trailer's adaptability to various tasks by allowing users to customize the trailer with specific tools or equipment.

In yet another embodiment, the MUT may be equipped with stabilizers that extend from the chassis to the ground. These stabilizers may, for example, prevent movement of the trailer during operation, such as when the fluid transfer pump module is in use. The stabilizers may provide increased safety and stability, particularly on uneven terrain.

In some embodiments, the MUT may include a control system that interfaces with the drive module and the fluid transfer pump module. This control system may, for example, regulate the operation of both modules to optimize energy usage and performance. The integration of a control system may enhance the efficiency and functionality of the trailer by coordinating the operation of its various components.

In various embodiments, the MUT may be configured to accommodate different types of interchangeable beds, such as a dump bed or a livestock bed. These interchangeable beds may, for example, be easily swapped out to suit different transportation needs. The ability to change beds without modifying the towing vehicle may increase the trailer's versatility and utility in diverse applications.

As an illustrative example, a seasonally adaptable trailer system may include a gooseneck trailer designed to be towed by a pickup truck with a bed. The gooseneck trailer may have a chassis that is at least partially exposed. The chassis may have several mount modules that extend outwardly along axes that intersect the main axis of the chassis. A drive module may be located at least partially forward of a vertical riser of the trailer's neck and may generate rotary motion from an energy storage module. The system may include several interchangeable modules that can be selectively and releasably attached to the trailer using the mount modules. These interchangeable modules may include a fluid transfer pump module that transfers fluid from an inflow conduit to an external receptacle. A pressure vessel may be configured to transport liquid propane gas and may have an outflow conduit that connects to the fluid transfer pump module below the chassis's top surface. The pressure vessel may have vessel mounts that extend outward to connect with the mount modules. A flatbed deck may cover the chassis where the pressure vessel is located when attached to the trailer. The flatbed deck may have deck mounts that extend outward to connect with the mount modules. The flatbed deck and the pressure vessel may be mounted to the trailer one at a time. The interchangeable modules may have a flat upper surface at or above the chassis level. The vessel mounts and deck mounts may have a flat lower surface that aligns with the flat upper surface of the interchangeable modules.

As an illustrative example, a seasonally adaptable trailer system may include a trailer designed to be towed by a pickup truck with a bed. The trailer may have a chassis that is at least partially exposed. The chassis may have several mount modules. A drive module may generate rotary motion from an energy storage module. The system may include several interchangeable modules that can be selectively and releasably attached to the trailer using the mount modules. These interchangeable modules may include a fluid transfer pump module that transfers fluid from an inflow conduit to an external receptacle. A pressure vessel may be configured to transport hazardous gas and may have an outflow conduit that connects to the fluid transfer pump module. The pressure vessel may have mounts that extend to connect with the mount modules. A flatbed deck may cover the chassis where the pressure vessel is located when attached to the trailer.

In some examples, the pressure vessel module and the flatbed deck may have module mounts that can be releasably attached to the interchangeable modules.

In some examples, the module mounts of the pressure vessel may extend outward from a tank and be located at or below the tank's bottom.

In some examples, the mount modules may be attached to and extend longitudinally away from the chassis along axes that intersect the chassis's main axis.

In some examples, the longitudinal extension may extend outboard of the chassis.

In some examples, the mount modules may include a first set on one side and a second set on the opposite side of the chassis (e.g., as shown in FIG. 1C).

In some embodiments, by way of example and not limitation, a first set of mount modules may, for example, be configured to support heavier interchangeable modules, such as the pressure vessel module. This configuration may provide enhanced stability during transport of heavy loads.

In some embodiments, a second set of mount modules may be designed to accommodate lighter modules, such as the flatbed deck module. This arrangement may facilitate easier installation and removal of the flatbed deck module, thereby increasing the efficiency of module interchangeability.

In some embodiments, the mount modules may include adjustable features that allow for the alignment of the interchangeable modules with varying dimensions. This adjustability may enhance the versatility of the MUT by enabling it to accommodate a wider range of module sizes.

In some embodiments, the mount modules may be equipped with locking mechanisms to secure the interchangeable modules in place during transit. These locking mechanisms may, for example, prevent unintentional detachment of the modules, thereby enhancing safety.

In some embodiments, the mount modules may include integrated electrical connectors that provide power to the interchangeable modules. This integration may, for example, facilitate the operation of electrically powered modules, such as the fluid transfer pump module, without requiring separate power connections.

In some examples, the mount modules may include modules for each interchangeable module that can be mounted simultaneously.

In some examples, at least two interchangeable modules may be mounted simultaneously.

In some examples, the fluid transfer pump module and the pressure vessel may be mounted simultaneously.

In some examples, the upper mounting surface of the mount modules may be at least flush or higher than the upper surface of the chassis in the area configured to receive an interchangeable module.

In some examples, the drive module may include a generator that can be electrically and releasably connected to the fluid transfer pump module.

In some examples, the energy storage module may include a fuel tank.

In some examples, the energy storage module may include a battery.

In some examples, the inflow conduit may not extend beyond the edge of the fluid transfer pump module's mounting platform.

In some examples, the fluid transfer pump module may include a reel, hose, and fluid dispensing meter.

In some examples, the pressure vessel may include a tank configured as a liquid propane gas tank. In various embodiments, the pressure vessel may, for example, include a tank configured for storing compressed natural gas. Some examples may include a tank configured for containing anhydrous ammonia. In some embodiments, the pressure vessel may include a tank configured for storing chlorine gas. Tanks configured for these gases may, for example, provide versatility in handling different types of hazardous and pressurized gases.

In some examples, the hazardous gas may include explosive gas.

In some examples, the interchangeable modules may include a bulk fuel transport module. For example, the bulk fuel transport module may be configured as a non-pressurized vessel module.

In some examples, the bulk fuel transport module may include a tank configured to transport liquid hydrocarbon fuel. The liquid hydrocarbon fuel may, for example, include gasoline. In some examples, the liquid hydrocarbon fuel may include diesel. Kerosene may be transported in some embodiments, for example. In some examples, the tank may be configured to transport aviation fuel. In some embodiments, the tank may be configured to transport biofuel. Transporting various types of liquid hydrocarbon fuels may, for example, provide flexibility in fuel delivery operations.

In some examples, a control system may regulate the operation of the fluid transfer pump module. In some examples, a control system may regulate the operation of the fluid transfer pump module. The control system may, for example, include sensors to monitor fluid levels within the tank 110. Monitoring fluid levels may, for example, prevent overfilling and/or facilitate efficient fluid transfer.

In various embodiments, the control system may regulate the operation of the drive module 500. The control system may, for example, adjust the power output of the motor 510 based on the load requirements of the MUT 100. Adjusting the power output may, for example, decrease energy consumption and/or extend the operational range of the trailer.

In some embodiments, the control system may be configured to manage the hydraulic power module 512. The control system may, for example, control the activation of the hydraulic pump 525 to operate the stabilizer 314. Controlling the stabilizer 314 may, for example, enhance the stability of the trailer during loading and unloading operations.

In various examples, the control system may regulate the operation of the solar panel 502. The control system may, for example, optimize the angle of the solar panel 502 to maximize energy capture. Optimizing energy capture may, for example, increase the efficiency of the renewable energy system.

In various implementations, the control system may regulate the operation of the delivery module 205. The control system may, for example, control the speed of the product pump 210 to match the flow rate requirements of the task.

In some examples, the control system may be configured to manage the operation of the MHPDS 405. The control system may, for example, coordinate the activation of hydraulic actuators to facilitate the conversion of the trailer into a roll-off trailer. Coordinating the hydraulic actuators may, for example, streamline the process of changing the trailer's configuration.

In various embodiments, the control system may regulate the operation of the engine 505. The control system may, for example, adjust the engine's throttle to maintain optimal performance under varying load conditions. Adjusting the throttle may, for example, enhance fuel efficiency and reduce emissions.

In some examples, the control system may manage the operation of the reservoir 515. The control system may, for example, monitor the fluid levels within the reservoir 515 to ensure adequate supply for hydraulic operations. Monitoring fluid levels may, for example, prevent interruptions in hydraulic functions.

In some embodiments, the control system may monitor the platform 308. The control system may, for example, activate an alarm upon detecting a person in or about the platform 308 during specific scenarios, such as while the engine 505 is running. In some embodiments, the control system may monitor the MUT 100 for safety. The control system may, for example, activate an alarm if the truck 105 is in motion while the deck 705 is occupied. In some examples, the control system may detect unauthorized access to the tank 110 and trigger a security alert. Various embodiments may include monitoring the coupling module 115 to ensure it is properly engaged, and may activate a warning if disengagement is detected during operation. In some examples, the control system may monitor the delivery module 205 and activate an alert if a product pump 210 malfunction is detected. Monitoring the trailer mount 310 for stability may be included in some embodiments, and an alert may be triggered if instability is detected.

In various examples, the control system may regulate the operation of the deck 705. The control system may, for example, control the extension of the deck 705. Controlling the deck 705 may, for example, increase the versatility of the trailer for different transportation needs.

In some examples, a heating module may heat fluid within a tank on the trailer, and the control system may regulate the heating module based on environmental conditions.

In some embodiments, a heating module may be integrated into the MUT to heat fluid within a tank on the trailer. The heating module may, for example, include an electric heating element. Electric heating elements may provide precise temperature control for the fluid.

In various embodiments, the heating module may include a combustion-based heater. Combustion-based heaters may offer rapid heating capabilities, which may be advantageous in colder environments.

In some embodiments, the control system may regulate the heating module based on environmental conditions. The control system may, for example, include temperature sensors. Temperature sensors may allow the system to adjust the heating module's output to maintain optimal fluid temperature.

In other embodiments, the control system may include a programmable logic controller (PLC). A PLC may enable automated adjustments to the heating module, enhancing operational efficiency.

In some embodiments, the control system may be configured to receive input from external weather data sources. Access to external weather data may allow the system to preemptively adjust heating parameters, potentially improving energy efficiency.

In some examples, the flatbed deck may support a load of at least 1,000 pounds. In some embodiments, the flatbed deck module may include a reinforced steel frame. The reinforced steel frame may, for example, provide increased structural integrity, which may be advantageous for supporting heavy loads.

In various embodiments, the flatbed deck module may be equipped with a non-slip surface. The non-slip surface may, for example, enhance safety by reducing the risk of cargo shifting during transport.

In certain embodiments, the flatbed deck module may include integrated tie-down points. The integrated tie-down points may, for example, facilitate secure attachment of cargo, which may prevent movement during transit.

In some embodiments, the flatbed deck module may be constructed from lightweight aluminum. The use of lightweight aluminum may, for example, reduce the overall weight of the trailer, which may improve fuel efficiency when towing.

In various embodiments, the flatbed deck module may be designed with a modular extension system. The modular extension system may, for example, allow the deck to be extended to accommodate longer cargo, increasing the versatility of the trailer.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A seasonally adaptable trailer system comprising:
a gooseneck trailer configured to be towed by a pickup truck with a bed, the gooseneck trailer comprising a chassis, wherein the chassis is at least partially exposed;
a plurality of mount modules provided on the chassis and extending outwardly from the chassis along corresponding longitudinal axes intersecting a longitudinal axis of the chassis;
a drive module disposed at least partially forward of a vertical riser of a neck of the gooseneck trailer and configured to generate rotary motion from an energy storage module;
a plurality of interchangeable modules, each configured to selectively and releasably couple to the gooseneck trailer via the plurality of mount modules, the plurality of interchangeable modules comprising:
a fluid transfer pump module configured to transfer fluid from an inflow conduit to a receptacle external to the gooseneck trailer;
a pressure vessel, configured to transport liquid propane gas, the pressure vessel comprising:
an outflow conduit configured to releasably couple to an intake conduit of the fluid transfer pump module below a top surface of the chassis; and
a plurality of vessel mounts extending outwardly from the pressure vessel to intersect with corresponding modules of the plurality of mount modules; and
a flatbed deck configured to cover the chassis in at least a location of the pressure vessel when connected to the gooseneck trailer, the flatbed deck comprising:
a plurality of deck mounts extending outwardly from the pressure vessel to intersect with corresponding modules of the plurality of mount modules,
wherein:
at least the flatbed deck and the pressure vessel are mutually exclusively mounted to the gooseneck trailer,
the plurality of interchangeable modules have a flat upper surface disposed at or above a level of the chassis, and
the plurality of vessel mounts and the plurality of deck mounts have a flat lower surface configured to align with and interface with the flat upper surface of the plurality of interchangeable modules.

2. A seasonally adaptable trailer system comprising:
a trailer configured to be towed by a pickup truck with a bed, the trailer comprising a chassis, wherein the chassis is at least partially exposed;
a plurality of mount modules provided on the chassis;
a drive module configured to generate rotary motion from an energy storage module;
a plurality of interchangeable modules, each configured to selectively and releasably couple to the trailer via the plurality of mount modules, the plurality of interchangeable modules comprising:
a fluid transfer pump module configured to transfer fluid from an inflow conduit to a receptacle external to the trailer;
a pressure vessel, configured to transport hazardous gas, the pressure vessel comprising:
an outflow conduit configured to releasably couple to an intake conduit of the fluid transfer pump module; and
a plurality of mounts extending from the pressure vessel to intersect with the plurality of mount modules; and
a flatbed deck configured to cover the chassis in at least the location of the pressure vessel when connected to the trailer.

3. The seasonally adaptable trailer system of claim 2, wherein at least the pressure vessel module and the flatbed deck comprise a plurality of module mounts configured to releasably couple to corresponding modules of the plurality of interchangeable modules.

4. The seasonally adaptable trailer system of claim 3, wherein the plurality of module mounts of the pressure vessel extend outward from a tank and are located at or below a bottom of the tank.

5. The seasonally adaptable trailer system of claim 2, the plurality of mount modules coupled to and longitudinally extending away from the chassis along corresponding axes intersecting a longitudinal axis of the chassis.

6. The seasonally adaptable trailer system of claim 5, wherein the longitudinally extending away comprises extending outboard of the chassis.

7. The seasonally adaptable trailer system of claim 3, wherein the plurality of mount modules comprises a first plurality of mount modules on a port side and a second plurality of mount modules on a starboard side of the chassis.

8. The seasonally adaptable trailer system of claim 7, wherein the plurality of mount modules comprises mount modules for each of the plurality of interchangeable modules configured to be mounted simultaneously.

9. The seasonally adaptable trailer system of claim 8, wherein at least two of the plurality of interchangeable modules are configured to be mounted simultaneously.

10. The seasonally adaptable trailer system of claim 9, wherein at least the fluid transfer pump module and the pressure vessel are configured to be mounted simultaneously.

11. The seasonally adaptable trailer system of claim 5, wherein an upper mounting surface of the plurality of mount modules is at least flush or higher than an upper surface of the chassis in a region configured to receive a corresponding module of the plurality of interchangeable modules.

12. The seasonally adaptable trailer system of claim 2, wherein the drive module comprises a generator configured to be electrically and releasably coupled to the fluid transfer pump module.

13. The seasonally adaptable trailer system of claim 12, wherein the energy storage module comprises a fuel tank.

14. The seasonally adaptable trailer system of claim 2, wherein the energy storage module comprises a battery.

15. The seasonally adaptable trailer system of claim 2, wherein the inflow conduit does not extend beyond an edge of a mounting platform of the fluid transfer pump module.

16. The seasonally adaptable trailer system of claim 2, wherein the fluid transfer pump module comprises a reel, hose, and fluid dispensing meter.

17. The seasonally adaptable trailer system of claim 2, wherein the pressure vessel comprises a tank configured as a liquid propane gas tank.

18. The seasonally adaptable trailer system of claim 2, wherein the hazardous gas comprises explosive gas.

19. The seasonally adaptable trailer system of claim 2, wherein the plurality of interchangeable modules comprises a bulk fuel transport module.

20. The seasonally adaptable trailer system of claim 19, wherein the bulk fuel transport module comprises a tank configured to transport liquid hydrocarbon fuel.

21. The seasonally adaptable trailer system of claim 2, further comprising a control system configured to regulate operation of the fluid transfer pump module.

22. The seasonally adaptable trailer system of claim 21, further comprising a heating module configured to heat fluid within a tank on the trailer, wherein the control system is further configured to regulate operation of the heating module based on environmental conditions.

23. The seasonally adaptable trailer system of claim 2, wherein the flatbed deck is configured to support a load of at least 1,000 pounds.
